(19) United States
(12) Patent Application Publication
(10) Pub. No.: US 2023/0328544 A1
(43) Pub. Date: Oct. 12, 2023

(54) AI-POWERED RADIO OVER TEMPERATURE HANDLING

(71) Applicant: Telefonaktiebolaget LM Ericsson (publ), Stockholm (SE)

(72) Inventor: Sepideh AFSAR DOOST, Ottawa (CA)

(21) Appl. No.: 18/044,218

(22) PCT Filed: Sep. 29, 2020
(86) PCT No.: PCT/IB2020/059107

§ 371 Date: Mar. 7, 2023

(51) Int. Cl. H04W 24/02; H04L 41/16

(52) U.S. Cl. CPC H04W 24/02; H04L 41/16

(57) ABSTRACT

A method for mitigating an undesired environmental condition in a communication network radio is provided. The method includes selecting a machine-learning model based on a plurality of data sources and determining a solution to mitigate the undesired environmental condition using the selected machine-learning model. An apparatus corresponding to the method for mitigating an undesired environmental condition is also provided. In addition, a computer storage medium storing a computer program for mitigating an undesired environmental condition in a communication network radio is provided.

### TECHNICAL FIELD

Wireless communication and in particular, apparatuses and methods for AI-powered radio over temperature handling.

### BACKGROUND

Radio access technologies, such as those provided based on standards promulgated by the 3rd Generation Partnership Project (3GPP), include communication network radios in network nodes, i.e., network node radios. Network node radios may be exposed to over-temperature conditions (e.g., upper exceptional range) in part due to high ambient temperature and high traffic load. Currently, there are multiple mitigation functions to handle over-temperature conditions including power back-off, hold-off, optimized scheduling, and radio shutdown with alarm as a last resort. Different radio products may utilize one or more of the over-temperature handling (OTH) approaches above. Each function is configured with parameters such as trigger and release temperature thresholds, back-off values, maximum time spent in OTH mode, or ramp-up/down period.

A rule-based software controller uses readings from different temperature sensors in the radio hardware to manage the over-temperature condition and cool down the radio. The controller has pre-defined rules, states and thresholds. State transitions between different operational modes (normal, back-off, etc.) are performed as the operating temperature rises and drops over time.

A radio unit OTH is a multi-dimensional problem. Internal and external factors such as ambient temperature, wind speed, time of the day, expected traffic, mean time between failures (MTBF) of devices, position and inaccuracy of the sensors can impact the thermal behavior of each radio unit. As a result, internal and external factors may impact the best strategy and configuration for handling over-temperature conditions.

Static configuration of a radio thermal controller in a rule-based paradigm (e.g., whether to select a OTH function or back-off level) is not optimum in all conditions. A rule-based controller does not get feedback from all internal and external factors, e.g., the factors described above, as getting feedback in this manner may become overcomplicated.

In addition, legacy behavior for over-temperature handling is often criticized for generating too many “Degraded Cell” alarms to the network node, which eventually forces the radio to enter a self-protection mode, i.e. forcing the radio unit to shut down. As such, there is a need for an improved intelligent temperature handling function that can in part minimize the network impact.

### SUMMARY

Some embodiments advantageously provide a method, an apparatus, and a computer storage medium for AI-powered radio over temperature handling.

According to one aspect of the present disclosure, a method for mitigating an undesired environmental condition in a communication network radio is provided. The method includes selecting a machine-learning model based on a plurality of data sources and determining a solution to mitigate the undesired environmental condition using the selected machine-learning model.

In some embodiments, the plurality of data sources include data associated with at least one of over temperature handling, OTH, process parameters, the OTH process parameters including at least one of a trigger, a release, and timings. The plurality of data sources may further include radio internal measurements including at least one of a temperature reading from a temperature sensor, a voltage of a device, a current of a device, a back-off parameter, a temperature sensor position, a temperature sensor inaccuracy measure, a physical resource block (PRB) utilization measure, and a mean time between failures (MTBF) of devices. The plurality of data sources may also include environmental factors including at least one of a time, an ambient temperature, a slope of a temperature change, and a weather condition and network key performance indicators, KPI, including at least one of a cell coverage, a latency, and a shutdown with an alarm.

In another embodiment, the selected machine-learning model includes at least supervised learning, SL, models. In some embodiments, the SL models include at least a model training feature, the model training feature including a supervised machine learning process for training and validation based at least on one of a feature engineering and a feature generation, the feature engineering and the feature generation being based on data from the data sources. The SL models may also include a deployment feature, the deployment feature including at least a predictive OTH model based at least on one of a feature engineering and a feature generation, the feature engineering and the feature generation being based on data from the data sources.

In one embodiment, the predictive OTH model is further based on the supervised machine learning process for training and validation. In some embodiments, the determined solution to mitigate the undesired environmental condition is determined by the predictive OTH model. The determined solution includes at least one of predicting when an over-temperature condition will occur, predicting a best point in time to start an OTH action, estimating when to release an OTH process and when to return to normal operation, choosing a best combination and an order of OTH processes, and estimating optimum parameters for at least a selected OTH process.

In some embodiments, the selected machine-learning model includes at least reinforcement learning, RL, models. In another embodiment, determining the solution to mitigate the undesired environmental condition is further based on a current state obtained from the data from at least one of the plurality of data sources. In some embodiments, determining the solution to mitigate the undesired environmental condition is further based on a reward associated with one of an internal and an external environment of the communication network radio.

In another embodiment, the reward includes at least a positive reward indicating a temperature of the communication network radio is reduced and at least one of the KPI is acceptable. In some embodiments, determining the solution to mitigate the undesired environmental condition includes determining an action including at least the OTH process and at least one parameter associated with the OTH process. In another embodiment, the undesired environmental condition is mitigated based at least on the determined solution.

According to another aspect of the present disclosure, an apparatus configured to mitigate an undesired environmental condition in a communication network radio is provided. The apparatus includes processing circuitry configured to select a machine-learning model based on a plurality of data sources and determine a solution to mitigate the undesired environmental condition using the selected machine-learning model.

In another embodiment, the plurality of data sources include data associated with at least one of over temperature handling, OTH, process parameters, the OTH process parameters including at least one of a trigger, a release, and timings. The plurality of data sources may further include radio internal measurements including at least one of a temperature reading from a temperature sensor, a voltage of a device, a current of a device, a back-off parameter, a temperature sensor position, a temperature sensor inaccuracy measure, a physical resource block (PRB) utilization measure, and a mean time between failures (MTBF) of devices. The plurality of data sources may also include environmental factors including at least one of a time, an ambient temperature, a slope of a temperature change, and a weather condition and network key performance indicators, KPI, including at least one of a cell coverage, a latency, and a shutdown with an alarm.

In another embodiment, the selected machine-learning model includes at least supervised learning, SL, models. In some embodiments, the SL models include at least a model training feature, the model training feature including a supervised machine learning process for training and validation based at least on one of a feature engineering and a feature generation, the feature engineering and the feature generation being based on data from the data sources. The SL models may also include a deployment feature, the deployment feature including at least a predictive OTH model based at least on one of a feature engineering and a feature generation, the feature engineering and the feature generation being based on data from the data sources.

In one embodiment, the predictive OTH model is further based on the supervised machine learning process for training and validation. In some embodiments, the determined solution to mitigate the undesired environmental condition is determined by the predictive OTH model. The determined solution includes at least one of predicting when an over-temperature condition will occur, predicting a best point in time to start an OTH action, estimating when to release an OTH process and when to return to normal operation, choosing a best combination and an order of OTH processes, and estimating optimum parameters for at least a selected OTH process.

In some embodiments, the selected machine-learning model includes at least reinforcement learning, RL, models. In another embodiment, determining the solution to mitigate the undesired environmental condition is further based on a current state obtained from the data from at least one of the plurality of data sources. In some embodiments, determining the solution to mitigate the undesired environmental condition is further based on a reward associated with one of an internal and an external environment of the communication network radio.

In another embodiment, the reward includes at least a positive reward indicating a temperature of the communication network radio is reduced and at least one of the KPI is acceptable. In some embodiments, determining the solution to mitigate the undesired environmental condition includes determining an action including at least the OTH process and at least one parameter associated with the OTH process. In another embodiment, the processing circuitry is further configured to mitigate the undesired environmental condition based at least on the determined solution.

According to another aspect of the present disclosure, a computer storage medium storing a computer program for mitigating an undesired environmental condition in a communication network radio is provided. The computer program includes computer program code, which, when executed on at least one processor causes the processor to perform a method according to some of the embodiments of the present disclosure.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to the principles in the present disclosure;

FIG. 2 is a block diagram of a network node in communication with a wireless device over an at least partially wireless connection according to some embodiments of the present disclosure;

FIG. 3 is a flowchart of an example method for mitigating an undesired environmental condition in a communication network radio according to an embodiment of the present disclosure;

FIG. 4 is a block diagram of an exemplary AI-powered radio over temperature handling implementation with supervised learning models according to an embodiment of the present disclosure; and

FIG. 5 is a block diagram of an example AI-powered radio over-temperature handling implementation with reinforcement learning according to an embodiment of the present disclosure.

### DETAILED DESCRIPTION

Some embodiments of the present disclosure provide methods and arrangement for AI-powered over temperature handling for a communication network radio using machine learning processes with various data inputs to model thermal behavior of radio products and strategize an optimum process, e.g., functions, correct order and timing of the functions and the best parameters.

In some embodiments, data-driven thermal behavioral models are trained using environmental parameters (e.g., ambient temperature, wind speed and direction), internal input features (e.g., sensor readings, power measurements) and radio network Key Performance Indicators (KPI). Rather than using pre-defined rules and parameters, a model-based process determines a strategy and settings of OTH processes, e.g., dynamically at a given frequency based on ongoing scenarios and conditions of the moment.

The methods and arrangements described in the present disclosure may result in high value and operational performance enhancements, e.g., minimizing traffic latency, back-off levels, and shutdown events. In addition, with respect to radio network performance, the methods and arrangements of the present disclosure allow for dynamically finding an optimal action at each moment given internal and external factors during the over-temperature conditions of a network node, e.g., communication network radio. The optimal/best action is defined as achieving regulated hardware temperature while minimizing impact to the radio network, i.e. minimizing traffic latency, back-off levels and shutdown events.

With respect to radio network performance, the methods and arrangements of the present disclosure allow for efficient radio system and software design, e.g., by replacing pre-defined OTH rules and parameters, which are sub-optimal in many of cases as they are not data-driven and statically defined. A model-based process allows an intelligent controller to choose OTH processes/functions and parameters for each of a plurality of conditions.

Before describing in detail exemplary embodiments, it is noted that the embodiments reside primarily in combinations of apparatus components and processing steps related to AI-powered radio over temperature handling. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU), Remote Radio Head (RRH), baseband unit (BBU), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the term “radio resource” is intended to indicate a frequency resource and/or a time resource. The time resource may correspond to any type of physical resource or radio resource expressed in terms of length of time. Examples of time resources are: symbol, time slot, subframe, radio frame, transmission time interval (TTI), interleaving time, etc. The frequency resource may correspond to one or more resource elements, subcarriers, resource blocks, bandwidth part and/or any other resources in the frequency domain. The radio resource may also indicate a combination of subcarriers, time slots, codes and/or spatial dimensions.

Even though the descriptions herein may be explained in the context of one of a Downlink (DL) and an Uplink (UL) communication, it should be understood that the basic principles disclosed may also be applicable to the other of the one of the DL and the UL communication. For DL communication, the network node is the transmitter and the receiver is the WD. For the UL communication, the transmitter is the WD and the receiver is the network node.

Although some the examples herein may be explained in the context of a WD being allocated radio resources on a physical channel for a periodic reference signal (e.g., SRS), it should be understood that the principles may also be applicable to other signals and other types of resources or other channels.

In some embodiments, the allocated radio resource may be allocated for a particular signal and on a particular channel. Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction. Examples of channels comprise a channel for low latency and/or high reliability transmission, in particular a channel for Ultra-Reliable Low Latency Communication (URLLC), which may be for control and/or data. In some embodiments, the channel described herein may be an uplink channel and in further embodiments may be a physical uplink shared channel (PUSCH) or a physical uplink control channel (PUCCH). In some embodiments, the channel may be a downlink channel, such as, a physical downlink control channel (PDCCH) or a physical downlink shared channel (PDSCH).

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements for AI-powered radio over temperature handling.

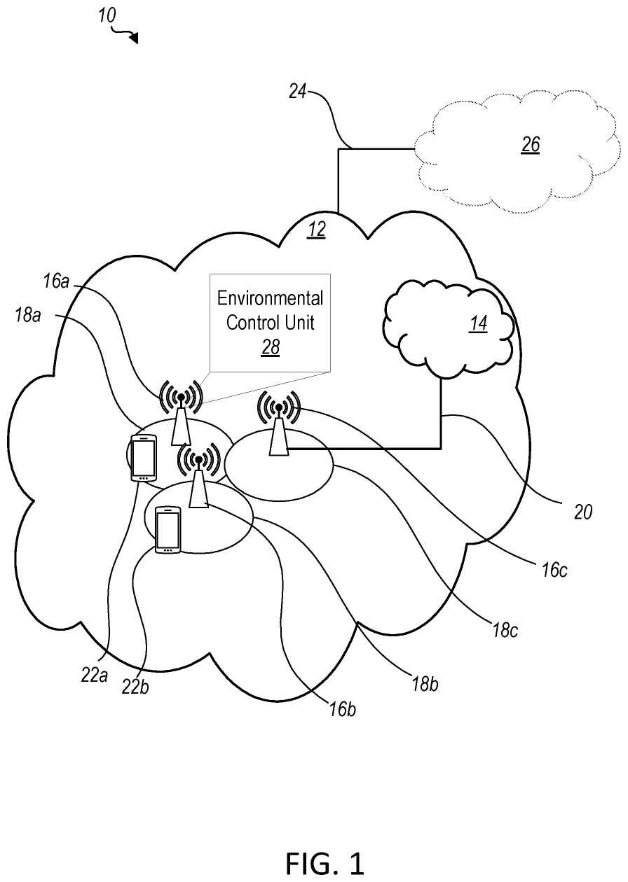

Referring again to the drawing figures, in which like elements are referred to by like reference numerals, there is shown in FIG. 1 is a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. Network nodes 16 are also referred to herein as “apparatus” in some embodiments. However, the “apparatus” is not required to be part of the network node 16, such as NBs, eNBs, gNBs, and may be a stand-alone “apparatus.”

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 is configured to include an environmental control unit 28 which is configured at least to cause the network node to mitigate an undesired environmental condition.

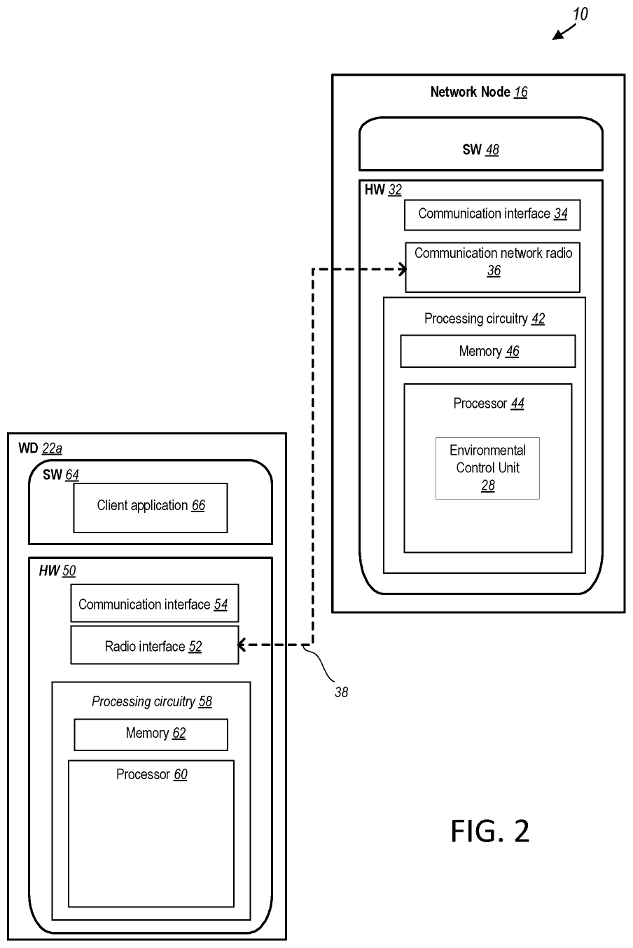

Example implementations, in accordance with an embodiment, of the WD 22 and network node 16 discussed in the preceding paragraphs will now be described with reference to FIG. 2.

The communication system 10 further includes a network node 16 provided in a communication system 10 and including hardware 32 enabling it to communicate with the WD 22. The hardware 32 may include a communication interface 34 for setting up and maintaining a wired or wireless connection with an interface of a different communication device of the communication system 10, as well as a communication network radio 36 for setting up and maintaining at least a wireless connection 38 with a WD 22 located in a coverage area 18 served by the network node 16. The communication network radio 36 may be formed as or may include, for example, one or more RF transmitters, one or more RF receivers, and/or one or more RF transceivers. Although the communication radio 36 is shown as part of network node 16 for ease of understanding, the communication radio 36 may be part of a separate network node that is not part of the “apparatus.” In other words, the embodiments of the present disclosure are not limited to the embodiment(s) shown in FIG. 2.

In the embodiment shown, the hardware 32 of the network node 16 further includes processing circuitry 42. The processing circuitry 42 may include a processor 44 and a memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) the memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

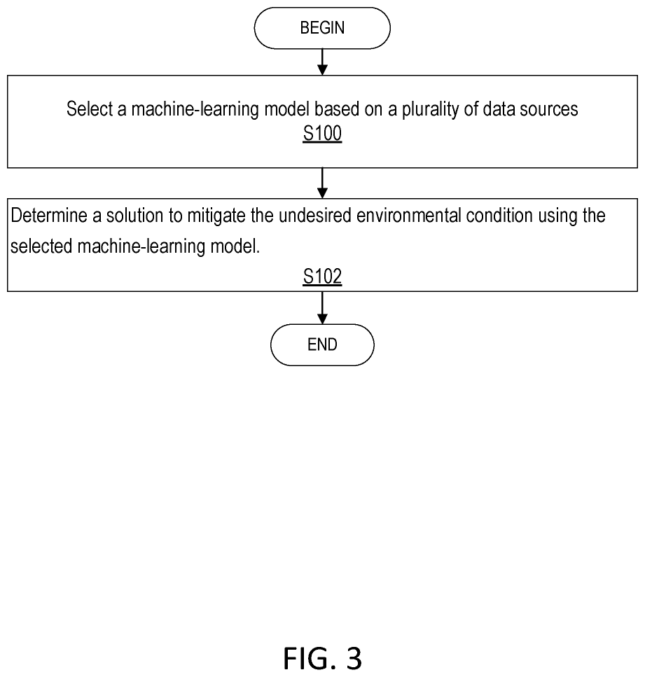

Thus, the network node 16 further has software 48 stored internally in, for example, memory 46, or stored in external memory (e.g., database, storage array, network storage device, etc.) accessible by the network node 16 via an external connection. The software 48 may be executable by the processing circuitry 42. The processing circuitry 42 may be configured to control any of the methods and/or processes described herein and/or to cause such methods, and/or processes to be performed, e.g., by network node 16. Processor 44 corresponds to one or more processors 44 for performing network node 16 functions described herein. The memory 46 is configured to store data, programmatic software code and/or other information described herein. In some embodiments, the software 48 may include instructions that, when executed by the processor 44 and/or processing circuitry 42, causes the processor 44 and/or processing circuitry 42 to perform the processes described herein with respect to network node 16. For example, processing circuitry 42 of the network node 16 may include environmental control unit 28 configured to perform network node methods discussed herein, such as the methods discussed with reference to FIG. 3 as well as other figures.

The communication system 10 further includes the WD 22 already referred to. The WD 22 may have hardware 50 that may include a radio interface 52 configured to set up and maintain a wireless connection 38 with a network node 16 serving a coverage area 18 in which the WD 22 is currently located. The radio interface 52 may be formed as or may include, for example, one or more RF transmitters, one or more RF receivers, and/or one or more RF transceivers.

The hardware 50 of the WD 22 further includes processing circuitry 58. The processing circuitry 58 may include a processor 60 and memory 62. In particular, in addition to or instead of a processor, such as a central processing unit, and memory, the processing circuitry 58 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 60 may be configured to access (e.g., write to and/or read from) memory 62, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 64, which is stored in, for example, memory 62 at the WD 22, or stored in external memory (e.g., database, storage array, network storage device, etc.) accessible by the WD 22. The software 64 may be executable by the processing circuitry 58. The software 64 may include a client application 66. The client application 66 may be operable to provide a service to a human or non-human user via the WD 22. The client application 66 may interact with the user to generate the user data that it provides.

The processing circuitry 58 may be configured to control any of the methods and/or processes described herein and/or to cause such methods, and/or processes to be performed, e.g., by WD 22. The processor 60 corresponds to one or more processors 60 for performing WD 22 functions described herein. The WD 22 includes memory 62 that is configured to store data, programmatic software code and/or other information described herein. In some embodiments, the software 64 and/or the client application 66 may include instructions that, when executed by the processor 60 and/or processing circuitry 58, causes the processor 60 and/or processing circuitry 58 to perform the processes described herein with respect to WD 22.

In some embodiments, the processing circuitry 58 of the wireless device 22 may be configured to use resources and/or receive and/or transmit on radio resources (e.g., physical layer resources, such as, physical downlink control channel, physical downlink shared channel, physical uplink control channel and/or physical uplink shared channel, etc.) that are allocated to the WD 22.

In some embodiments, the inner workings of the network node 16 and WD 22, may be as shown in FIG. 2 and independently, the surrounding network topology may be that of FIG. 1.

Although FIGS. 1 and 2 show various “units” such as each of environmental control unit 28 as being within a processor, it is contemplated that these units may be implemented such that a portion of the unit is stored in a corresponding memory within the processing circuitry. In other words, the units may be implemented in hardware or in a combination of hardware and software within the processing circuitry. Further, it is contemplated that the environmental control unit 28 can be placed and run in a cloud environment/device. For example, in a cloud-based RAN, there are non-real time and near-real time applications such as the AI-powered radio OTH. This may be applicable for implementations in an Open Radio Access Network (ORAN) environment.

FIG. 3 is a flowchart of an example method for a network node 16 to mitigate an undesired environmental condition. One or more Blocks and/or functions and/or methods performed by the network node 16 may be performed by one or more elements of network node 16, such as by environmental control unit 28 in processing circuitry 42, processor 44, communication interface 34, communication network radio 36, to detect an over temperature condition, such as for example in hardware 32 and/or 50, according to the example method. The example method includes selecting (Block S100), such as by environmental control unit 28 in processing circuitry 42, processor 44, communication interface 34, communication network radio 36, a machine-learning model based on a plurality of data sources and determine (Block S102), such as by environmental control unit 28 in processing circuitry 42, processor 44, communication interface 34, communication network radio 36, a solution to mitigate the undesired environmental condition using the selected machine-learning model.

In some embodiments, the plurality of data sources include data associated with at least one of over temperature handling, OTH, process parameters 68, the OTH process parameters 68 including at least one of a trigger, a release, and timings. The plurality of data sources may further include radio internal measurements 70 including at least one of a temperature reading from a temperature sensor, a voltage of a device, a current of a device, a back-off parameter, a temperature sensor position, a temperature sensor inaccuracy measure, a physical resource block (PRB) utilization measure, and a mean time between failures (MTBF) of devices. The plurality of data sources may also include environmental factors 72 including at least one of a time, an ambient temperature, a slope of a temperature change, and a weather condition and network key performance indicators, KPI, 74 including at least one of a cell coverage, a latency, and a shutdown with an alarm.

In another embodiment, the selected machine-learning model includes at least supervised learning, SL, models. In some embodiments, the SL models include at least a model training feature 76, the model training feature 76 including a supervised machine learning process for training and validation 82 based at least on one of a feature engineering and a feature generation 80, the feature engineering and the feature generation 80 being based on data from the data sources. The SL models may also include a deployment feature 78, the deployment feature 78 including at least a predictive OTH model 86 based at least on one of a feature engineering and a feature generation 84, the feature engineering and the feature generation 84 being based on data from the data sources 68, 70, 72, 74.

In one embodiment, the predictive OTH model 86 is further based on the supervised machine learning process for training and validation 82. In some embodiments, the determined solution to mitigate the undesired environmental condition is determined, such as by environmental control unit 28 in processing circuitry 42, processor 44, communication interface 34, communication network radio 36, by the predictive OTH model 86. The determined solution being a model-based OTH 88 includes at least one of predicting, such as by environmental control unit 28 in processing circuitry 42, processor 44, communication interface 34, communication network radio 36, when an over-temperature condition will occur, predicting a best point in time to start an OTH action, estimating, such as by environmental control unit 28 in processing circuitry 42, processor 44, communication interface 34, communication network radio 36, when to release an OTH process and when to return to normal operation, choosing, such as by environmental control unit 28 in processing circuitry 42, processor 44, communication interface 34, communication network radio 36, a best combination and an order of OTH processes, and estimating, such as by environmental control unit 28 in processing circuitry 42, processor 44, communication interface 34, communication network radio 36, optimum parameters for at least a selected OTH process.

In some embodiments, the selected machine-learning model includes at least reinforcement learning, RL, models. In another embodiment, determining the solution to mitigate the undesired environmental condition is further based on a current state 96 obtained from the data from at least one of the plurality of data sources. In some embodiments, determining the solution to mitigate the undesired environmental condition is further based on a reward 98 associated with one of an internal and an external environment 94 of the communication network radio 36.

In another embodiment, the reward 98 includes at least a positive reward indicating, such as by environmental control unit 28 in processing circuitry 42, processor 44, communication interface 34, communication network radio 36, a temperature of the communication network radio is reduced and at least one of the KPI is acceptable. In some embodiments, determining the solution to mitigate the undesired environmental condition includes determining, such as by environmental control unit 28 in processing circuitry 42, processor 44, communication interface 34, communication network radio 36, an action 92 including at least the OTH process and at least one parameter associated with the OTH process. In another embodiment, the undesired environmental condition is mitigated, such as by environmental control unit 28 in processing circuitry 42, processor 44, communication interface 34, communication network radio 36, based at least on the determined solution.

Having described the general process flow of arrangements of the disclosure and having provided examples of hardware and software arrangements for implementing the processes and functions of the disclosure, the sections below provide details and examples of arrangements for adaptively configuring bandwidth part to enable fast wireless device reconfiguration which may be implemented by the network node 16 and/or wireless device 22.

Some embodiments provide one or more techniques for mitigating an undesired environmental condition. Various types of input data can affect an over-temperature condition of a radio and therefore may be considered for model training. Examples of data sources are (1) different parameters of OTH methods (e.g., trigger, release, timings); (2) radio internal measurements including but not limited to temperature sensors readings and current/voltage of devices; back-off parameters (e.g., trigger, release, timings), temperature sensor position and inaccuracy, physical resource block (PRB) utilization (e.g., site and location dependent), mean time between failures (MTBF) of devices; (3) Environmental factors, such as time (e.g., time of the day), ambient temperature and slope of the temperature change; other weather conditions (e.g., wind speed/direction, sun radiation); and (4) network Key Performance Indicators (KPIs), such as cell coverage, latency, shutdown with alarm.

Given input data, such as input data described above, at least two types of machine learning models for a complete OTH process are described: (1) Supervised Learning (SL) models; and (2) Reinforcement Learning (RL) models.

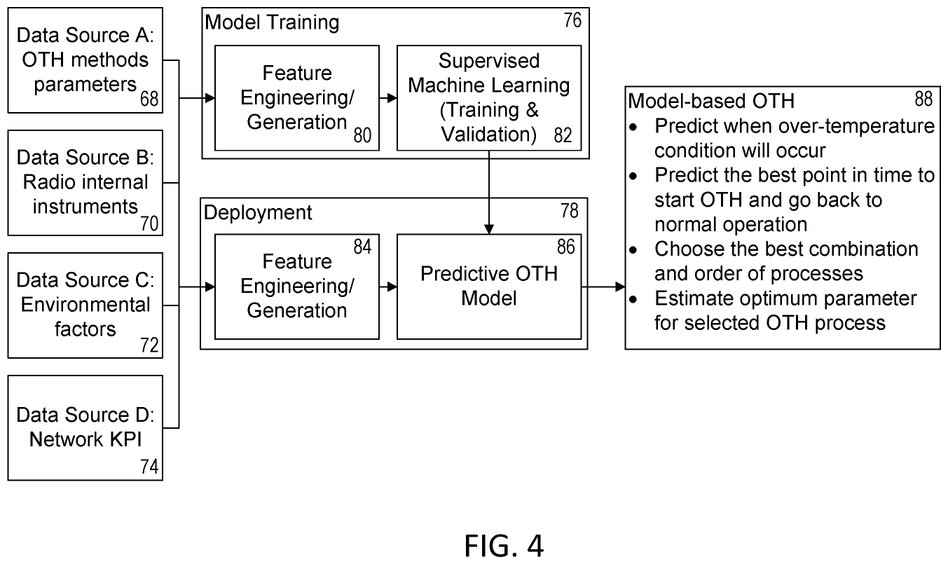

FIG. 4 is block diagram of an example AI-powered radio over temperature handling implemented with supervised machine learning. Data sources (A, B, C, and D) 68, 70, 72, and 74, respectively, (also described above), may provide data inputs to model training 76 and deployment 78. Each one of model training 76 and deployment 78 may include a feature engineering/generation 80, 84, that receives data from any of data sources 68, 70, 72, and 74. Feature engineering and generation may collect raw data, such as by environmental control unit 28 in processing circuitry 42, processor 44, communication interface 34, communication network radio 36, from different data sources 68, 70, 72, 74 goes through a feature mapping and generation pipeline, which after cleaning and correcting the raw data, feature engineering/generation 80, 84 maps the input features, such as by environmental control unit 28 in processing circuitry 42, processor 44, communication interface 34, communication network radio 36, to desired attributes used in the next step. An example is calculating cell coverage and latency from performance monitoring (PM) counters. Another example of a feature is an estimated ambient temperature based on internal hardware temperature sensors. Some of the features (e.g., back-off parameters, voltage/current reading) can be decided to be used in raw data format with no further processing.

Supervised machine learning, including training and validation, 82 may make determinations, such as by environmental control unit 28 in processing circuitry 42, processor 44, communication interface 34, communication network radio 36, which may be based at least on inputs received from feature engineering/generation 80. Further, supervised machine learning may include any one of supervised machine learning, including but not limited to decision trees, random forest, support vector machines, Naïve Bayes, deep learning, and neural networks.

Supervised training, such as in supervised machine learning 82, may be performed either online or offline (e.g., one-off), such as by environmental control unit 28 in processing circuitry 42, processor 44, communication interface 34, communication network radio 36, depending on availability of cloud computational resources of a network node 16 for machine learning applications. However, offline training may be beneficial due to intricacy of online training. In case of offline training, models may be saved locally (e.g., in the network node 16, OTH controller, local storage) and deployed for inference in the field based on input features (e.g., current ambient temperature, internal temperature, traffic load). Batch training once a model is deployed may also be performed.

Predictive OTH model 86 may receive an input, such as by environmental control unit 28 in processing circuitry 42, processor 44, communication interface 34, communication network radio 36, from feature engineering/generation 84 and/or supervised machine learning 82 to produce an output. For example, SL models may infer, such as by environmental control unit 28 in processing circuitry 42, processor 44, communication interface 34, communication network radio 36, a function from labeled training datasets consisting of pairs of inputs and outputs. Using either linear and tree-based supervised learning models or deep learning neural networks, the following model-based OTH 88 may be output: predicting when over-temperature condition will happen, predicting a best point in time to start OTH, estimate when to release a OTH process and go back to normal operation, choose a best combination and order of processes, and estimating optimum parameters for selected OTH processes.

An example of a use case scenario of an undesirable environmental condition and response is as follows. At a specific time of the day due to high traffic and high ambient temperature, the radio enters an over-temperature condition. A current rule-based controller starts a OTH process such as back-off. When the back-off does not lower an internal temperature of the network node 16, the controller attempts more aggressive OTH process until that may lead to a radio shutdown.

Given the same use case scenario as described above, i.e., at a specific time of the day due to high traffic and high ambient temperature, the radio enters an over-temperature condition. The example AI-powered radio over temperature handling implemented with supervised machine learning, as shown in FIG. 4, may respond, such as by environmental control unit 28 in processing circuitry 42, processor 44, communication interface 34, communication network radio 36, to the use case scenario as follows. With a model-based solution, a model learns, such as by environmental control unit 28 in processing circuitry 42, processor 44, communication interface 34, communication network radio 36, the thermal pattern of a radio, e.g., network node 16, and is able to predict, such as by environmental control unit 28 in processing circuitry 42, processor 44, communication interface 34, communication network radio 36, an imminent over-temperature condition in advance. Having this knowledge in advance, the controller, such as by environmental control unit 28 in processing circuitry 42, processor 44, communication interface 34, communication network radio 36, will decide whether to start an over-temperature mitigation early enough to avoid more aggressive OTH processes and to avoid undesirable shutdowns in the near future. In addition, the controller may determine, such as by environmental control unit 28 in processing circuitry 42, processor 44, communication interface 34, communication network radio 36, an optimum strategy in terms of OTH processes and settings to minimize impact on network performance.

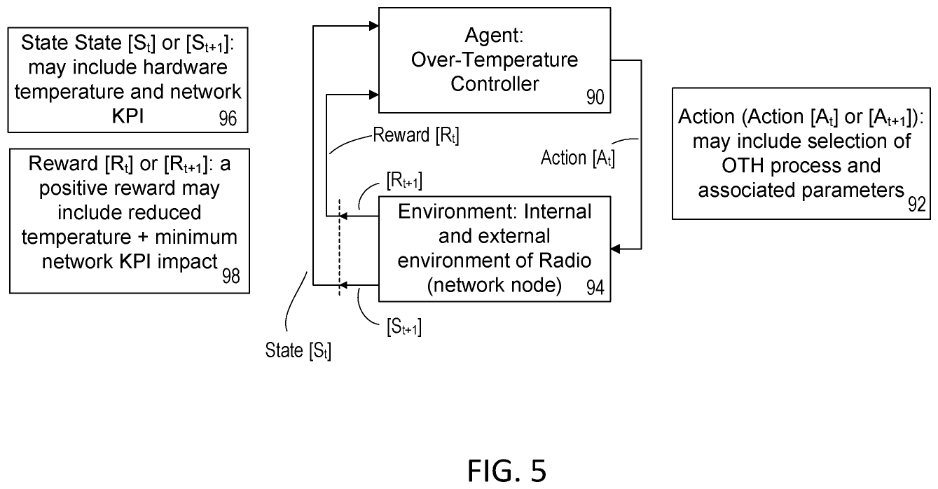

FIG. 5 is a block diagram that illustrates an example of AI-powered radio over-temperature handling implemented with reinforcement learning (RL), which may include at least one of an agent 90, an action 92, an environment 94, a state 96, and a reward 98. In some embodiments, the agent 90 may be included in the network node 16 and/or in the communication network radio 96, or may be a stand-alone agent. In the case of RL models, OTH is a state-action pair relationship, which depending at least on a current state 96 of an environment 94, a suitable action 92, e.g., Action [Aₜ], is performed, such as by environmental control unit 28 in processing circuitry 42, processor 44, communication interface 34, communication network radio 36. RL models may be used to enable agents 90, e.g., software-defined agents, to learn the best actions given current conditions, such as by environmental control unit 28 in processing circuitry 42, processor 44, communication interface 34, communication network radio 36. In other words, the four essential elements of the RL models according to some embodiments of the present disclosure include at least an agent 90, an action 92, selection of OTH processes (e.g., back-off, hold-off), selection of parameters settings of a selected OTH process (e.g. thresholds, levels, timings), an environment 94, and a reward 98. An agent may be an OTH controller that decides, such as by environmental control unit 28 in processing circuitry 42, processor 44, communication interface 34, communication network radio 36, what actions 92 to take when an undesirable environmental condition occurs, e.g., over-temperature condition. An environment 94 may include an internal and/or an external environment of a radio and/or network node 16. Rewards 98 may be positive, for example, when a radio temperature is reduced while an impact to network KPIs is acceptable, e.g., within an acceptable range.

In an embodiment, in an RL framework, an agent 90 observes, such as by environmental control unit 28 in processing circuitry 42, processor 44, communication interface 34, communication network radio 36, a state 96 of an environment 94. The state 96 may be obtained from data from a plurality of data sources, e.g., a network node 16 hardware temperature and/or a network KPI. Then, the agent 90 determines/selects and performs, such as by environmental control unit 28 in processing circuitry 42, processor 44, communication interface 34, communication network radio 36, an action 92 as described above. Performing the action 92 changes the state 96 of the environment 94 and the agent 90 receives, such as by environmental control unit 28 in processing circuitry 42, processor 44, communication interface 34, communication network radio 36, a reward 98 (e.g., feedback). Based on the received reward 98 (e.g., positive, or negative), the agent 90 determines, such as by environmental control unit 28 in processing circuitry 42, processor 44, communication interface 34, communication network radio 36, the next action iteratively (e.g., [Aₜ], [Aₜ₊₁], [Rₜ], [Rₜ₊₁], [Sₜ], [Sₜ₊₁]). This way, the agent 90 learns to develop an effective policy that minimizes the network impact while regulating the radio hardware temperature.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Julia, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method for mitigating an undesired environmental condition in a communication network radio, the method comprising:
selecting a machine-learning model based on a plurality of data sources; and
determining a solution to mitigate the undesired environmental condition using the selected machine-learning model.

2. The method of claim 1, wherein the plurality of data sources include data associated with at least one of:
over temperature handling, OTH, process parameters, the OTH process parameters including at least one of a trigger, a release, and timings;
radio internal measurements including at least one of a temperature reading from a temperature sensor, a voltage of a device, a current of a device, a back-off parameter, a temperature sensor position, a temperature sensor inaccuracy measure, a physical resource block (PRB) utilization measure, and a mean time between failures (MTFB) of devices;
environmental factors including at least one of a time, an ambient temperature, a slope of a temperature change, and a weather condition; and
network key performance indicators, KPI, including at least one of a cell coverage, a latency, and a shutdown with an alarm.

3. The method of claim 1, wherein the selected machine-learning model includes at least supervised learning, SL, models.

4. The method of claim 3, wherein the SL models include at least:
a model training feature, the model training feature including a supervised machine learning process for training and validation based at least on one of a feature engineering and a feature generation, the feature engineering and the feature generation being based on data from the data sources; and
a deployment feature, the deployment feature including at least a predictive OTH model based at least on one of a feature engineering and a feature generation, the feature engineering and the feature generation being based on data from the data sources.

5. The method of claim 4, wherein the predictive OTH model is further based on the supervised machine learning process for training and validation.

6. The method of claim 5, wherein the determined solution to mitigate the undesired environmental condition is determined by the predictive OTH model, the determined solution being a model-based OTH including at least one of:
predicting when an over-temperature condition will occur;
predicting a best point in time to start an OTH action;
estimating when to release an OTH process and when to return to normal operation;
choosing a best combination and an order of OTH processes; and
estimating optimum parameters for at least a selected OTH process.

7. The method of claim 1, wherein the selected machine-learning model includes at least reinforcement learning, RL, models.

8. The method of claim 7, wherein determining the solution to mitigate the undesired environmental condition is further based on a current state obtained from the data from at least one of the plurality of data sources.

9. The method of claim 7, wherein determining the solution to mitigate the undesired environmental condition is further based on a reward associated with one of an internal and an external environment of the communication network radio.

10. The method of claim 9, wherein the reward includes at least a positive reward indicating a temperature of the communication network radio is reduced and at least one of the KPI is acceptable.

11. The method of claim 7, wherein determining the solution to mitigate the undesired environmental condition includes determining an action including at least the OTH process and at least one parameter associated with the OTH process.

12. The method of claim 1, the method further includes mitigating the undesired environmental condition based at least on the determined solution.

13. An apparatus configured to mitigate an undesired environmental condition in a communication network radio, the apparatus comprising:
processing circuitry configured to:
select a machine-learning model based on a plurality of data sources; and
determine a solution to mitigate the undesired environmental condition using the selected machine-learning model.

14. The apparatus of claim 13, wherein the plurality of data sources include data associated with at least one of:
over temperature handling, OTH, process parameters, the OTH process parameters including at least one of a trigger, a release, and timings;
radio internal measurements including at least one of a temperature reading from a temperature sensor, a voltage of a device, a current of a device, a back-off parameter, a temperature sensor position, a temperature sensor inaccuracy measure, a physical resource block (PRB) utilization measure, and a mean time between failures (MTFB) of devices;
environmental factors including at least one of a time, an ambient temperature, a slope of a temperature change, and a weather condition; and
network key performance indicators, KPI, including at least one of a cell coverage, a latency, and a shutdown with an alarm.

15. The apparatus of claim 13, wherein the selected machine-learning model includes at least supervised learning, SL, models.

16. The apparatus of claim 15, wherein the SL models include at least:
a model training feature, the model training feature including a supervised machine learning process for training and validation based at least on one of a feature engineering and a feature generation, the feature engineering and the feature generation being based on data from the data sources; and
a deployment feature, the deployment feature including at least a predictive OTH model based at least on one of a feature engineering and a feature generation, the feature engineering and the feature generation being based on data from the data sources.

17. The apparatus of claim 16, wherein the predictive OTH model is further based on the supervised machine learning process for training and validation.

18. The apparatus of claim 17, wherein the determined solution to mitigate the undesired environmental condition is determined by the predictive OTH model, the determined solution being a model-based OTH including at least one of:
predicting when an over-temperature condition will occur;
predicting a best point in time to start an OTH action;
estimating when to release an OTH process and when to return to normal operation;
choosing a best combination and an order of OTH processes; and
estimating optimum parameters for at least a selected OTH process.

19. The apparatus of claim 13, wherein the selected machine-learning model includes at least reinforcement learning, RL, models.

20. The apparatus of claim 19, wherein determining the solution to mitigate the undesired environmental condition is further based on a current state obtained from the data from at least one of the plurality of data sources.

21. The apparatus of claim 19, wherein determining the solution to mitigate the undesired environmental condition is further based on a reward associated with one of an internal and an external environment of the communication network radio.

22. The apparatus of claim 21, wherein the reward includes at least a positive reward indicating a temperature of the communication network radio is reduced and at least one of the KPI is acceptable.

23. The apparatus of claim 19, wherein determining the solution to mitigate the undesired environmental condition includes determining an action including at least the OTH process and at least one parameter associated with the OTH process.

24. The apparatus of claim 13, the processing circuitry being further configured to:
mitigate the undesired environmental condition based at least on the determined solution.

25. A computer storage medium storing a computer program for mitigating an undesired environmental condition in a communication network radio, the computer program comprising computer program code, which, when executed on at least one processor causes the processor to perform a method for mitigating an undesired environmental condition in a communication network radio, the method comprising:
selecting a machine-learning model based on a plurality of data sources; and
determining a solution to mitigate the undesired environmental condition using the selected machine-learning model.
